(19) United States
(12) Patent Application Publication
(10) Pub. No.: US 2004/0262528 A1
(43) Pub. Date: Dec. 30, 2004

(54) Small field view gamma camera

(76) Inventors: Roman Zaikin, Mahwah, NJ (US); Marcia Suzuki, Ramsey, NJ (US)

Correspondence Address: FLEIT KAIN GIBBONS GUTMAN & BONGINI, COURVOISIER CENTRE II, SUITE 404, 601 BRICKELL KEY DRIVE, MIAMI, FL, 33131, US

(21) Appl. No.: 10/609,142

(22) Filed: Jun. 26, 2003

(51) Int. Cl. G01T 1/20

(52) U.S. Cl. 250/369

(57) ABSTRACT

A gamma camera system having a small field of view that includes a plurality of modules, a module support board on which the modules are mounted, a module interface board, signal amplifier and detection logic mounted on the module support board, a computer interface board mounted in a computer and connected to an internal bus in the computer, and a serial connection between the module support board and the computer interface board. Each module includes a scintillation crystal array, a photodiode array coupled to the scintillation crystal array, a first PETRIC circuit coupled to the array of photodiodes in parallel to determine the crystal of highest peak analog signal and its address in the array and provide an output thereof. A second PETRIC circuit receives the analog outputs of the first PETRIC circuits and determines the crystal of the highest peak analog signal of all the modules and its address in the arrays and provides an output thereof. An analog-to-digital converter receives the output of the second PETRIC and outputs a corresponding digital signal. A first programmable field gate array is mounted on the module interface board to receive the digital signals and to output in serial fashion. A serial connection between the module interface board and the computer interface board receives the serialized digital signals output by the first programmable field gate array. A second programmable field gate array mounted on the computer interface board receives the serialized digital signals from the serial connection. A microprocessor with memory is mounted on the computer interface board to receive the digital signals from the second programmable field gate array, store the signals and output the signals in parallel fashion, and a circuit mounted on the computer interface board to receive the signals in parallel from the microprocessor and to forward them to the computer via its internal bus.

### BACKGROUND OF THE INVENTION

1. Field of the Invention

The present invention relates to the field of radiation imaging for medical applications, and more particularly to a small field of view gamma radiation imaging system, including a novel gamma camera, and to a method of imaging relying upon gamma radiation to obtain a small field of view.

2. Prior Art

Since its development in the 1950s, the gamma camera has proven to be an important instrument in nuclear medicine imaging. However, to date gamma cameras are not optimized for tasks where the field of view is small, such as, imaging of the breast, thyroid or lymph nodes because the present gamma cameras are of bulky size and have significant dead space around the periphery of the camera. The large camera size makes access to the small areas difficult, resulting in a long imaging distance which decreases spatial resolution and detection sensitivity. Other small organ imaging applications, small animal imaging applications, and applications involving surgical probes would all also benefit from a compact gamma camera.

### SUMMARY OF THE INVENTION

The foregoing disadvantages and problems of the prior art are solved by the present invention by the provision of a gamma camera system that is small enough to function as an effective surgical probe, during an operation, particularly with respect to monitoring thyroid, breast, or lymph node, as examples. At the same time, the gamma camera system of the present invention is light enough and integrated enough that it does not impose a physical hardship on a physician using it during an on-going operation. Further, the system of the present invention provides an excellent small field of view camera in order to pinpoint necessary details for successfully monitoring the operation. Most important, the system functions with reduced power consumption.

These advantages and objects of the invention are realized by the novel gamma camera system of the invention which comprises a camera based on a 2×2 array of 64 pixel imaging modules made up from CsI crystals coupled to low noise Si PIN photodiodes that are readout by an ASIC (PETRIC—positron emission tomography readout integrated circuit), arranged on a module support board 11 with the ASIC (including a WTA circuit) being fed from the photodiodes in parallel by 64 front end channels. The ASIC amplifies the photodiode signals and determines the crystal of interaction, i.e. the largest signal (peak signal). Another ASIC is mounted on a module interface board 13 and functions as a WTA to determine the module with the largest signal. A FLEX circuit comprised of a field programmable gate array, and a microcontroller serve to provide control and timing signals. The peak signal digitized and its digital address are fed via a serial interface or connection to a computer PCI interface board containing a PCI interface, another FLEX to provide control and timing signals, and a digital signal processor to store the camera image, and feed it to the computer in parallel fashion. The PCI interface board is mounted in a computer connected to the PCI bus. Processing and display are performed in the computer according to a mandated routine.

The invention further contemplates a gamma camera system having a small field of view comprising: a plurality of modules, a support on which the modules are mounted, a module interface including signal amplifier and first detection logic, a computer interface for mounting in a computer and connecting to an internal bus in the computer, a serial data connection between the module interface and the computer interface, each said module including a scintillation crystal array, a photodiode array coupled to the scintillation crystal array, second detection logic coupled to the array of photodiodes for reception of data in parallel and to determine the crystal of highest peak analog signal and its address in the array and providing an output thereof, the first detection logic of the module interface receiving the analog outputs of the second detection logics and determining the crystal of the highest peak analog signal of all the modules and its address in the arrays and providing an analog output thereof, an analog-to-digital converter receiving the output of the first detection logic and outputting a corresponding digital signal, a first controller mounted on the module interface to receive said digital signals and to output in serial data fashion, a serial connection between the module interface and the computer interface receiving the serialized digital data signals output by the first controller, a second controller mounted on the computer interface receiving the serialized digital data signals from the serial connection, microprocessor with memory mounted on the computer interface to receive the digital data signals from the second controller, store the signals and output the signals in parallel data fashion to the computer via its internal bus.

The gamma camera system according to the above in which the second detection logic includes a PETRIC circuit, and where the PETRIC circuit includes a “winner-take-all” circuit. Also, the second detection logic includes a programmable non-volatile memory. Further, the first detection logic includes a PETRIC circuit, which includes a “winner-take-all” circuit. Also, the first controller includes programmable logic devices, one of which is a microcontroller. Further, the second controller includes programmable logic devices.

The system can include a high voltage power supply provided on the computer interface. Also, the computer interface includes PCI circuitry to couple to a computer internal PCI bus.

In addition to the system described above, the invention contemplates a gamma camera for use in a gamma camera system with a small field of view comprising: a plurality of modules, a support on which the modules are mounted, a module interface including signal amplifier and first detection logic, each said module including a scintillation crystal array, a photodiode array coupled to the scintillation crystal array, second detection logic coupled to the array of photodiodes for reception of data in parallel and to determine the crystal of highest peak analog signal and its address in the array and providing an output thereof, the first detection logic of the module interface receiving the analog outputs of the second detection logics and determining the crystal of the highest peak analog signal of all the modules and its address in the arrays and providing an analog output thereof, an analog-to-digital converter receiving the output of the first detection logic and outputting a corresponding digital signal, a controller mounted on the module interface to receive said digital signals and to output in serial data fashion to a serial connection between the module interface and a computer for introduction into the computer via its internal bus.

In the second detection logic of the gamma camera, a PETRIC circuit can be included, and the PETRIC circuit can include a “winner-take-all” circuit. Also, the second detection logic can include a programmable non-volatile memory. Further, the first detection logic can include a PETRIC circuit, and the PETRIC circuit can include a “winner-take-all” circuit. Also, the first controller includes programmable logic devices, and one of these devices can be a microcontroller. Also, the second controller includes programmable logic devices.

In a preferred arrangement, the gamma camera has four modules arranged in a 2×2 array, and wherein each module provides an 8×8 array. Each module is about 20 mm wide and 20 mm long and includes CsI(TI) crystals about 2.25 mm×2.25 mm×5 mm deep. The module includes 8×8 Si PIN photodiodes.

The invention further contemplates a gamma camera system having a small field of view comprising a plurality of modules, a module support board on which the modules are mounted, a module interface board, signal amplifier and detection logic mounted on the module support board, a computer interface board mounted in a computer and connected to an internal bus in the computer, a serial connection between the module support board and the computer interface board, each said module including a scintillation crystal array, a photodiode array coupled to the scintillation crystal array, a first PETRIC circuit coupled to the array of photodiodes in parallel to determine the crystal of highest peak analog signal and its address in the array and providing an output thereof, a second PETRIC circuit receiving the analog outputs of the first PETRIC circuits and determining the crystal of the highest peak analog signal of all the modules and its address in the arrays and providing an output thereof, an analog-to-digital converter receiving the output of the second PETRIC and outputting a corresponding digital signal, a first programmable field gate array mounted on the module interface board to receive said digital signal and to output in serial fashion, a serial connection between the module interface board and the computer interface board receiving the serialized digital signals output by the first programmable field gate array, a second programmable field gate array mounted on the computer interface board receiving the serialized digital signals from the serial connection, microprocessor with memory mounted on the computer interface board to receive the digital signals from the second programmable field gate array, store the signals and output the signals in parallel fashion, and a circuit mounted on the computer interface board to receive the signals in parallel from the microprocessor and to forward them to the computer via its internal bus.

The gamma camera system described above includes an EEPOT mounted on the module support board controlling each module.

The invention also includes a method of imaging comprising the steps of

a. detecting on a pixel by pixel basis gamma radiation by a small field of view camera having a module array,

b. amplifying and determining the pixel of each module with the highest amplitude signal,

c. sending the determined amplitude signals of all the modules in parallel to a circuit to select, as between these determined amplitude signals, which pixel has the highest amplitude,

d. reading the pixel address of the selected pixel in digital form,

e. converting the highest amplitude of the selected pixel into digital form,

f. sending the digital signals via a serial interface to a computer interface board and storing the signals in a memory, and

g. sending the stored signals in parallel to an input bus of the computer for display by the computer.

In the method described above, steps a. and b. are performed by a PETRIC. Also, the input bus is a PCI bus.

Other and further advantages and objects of the present invention will become readily apparent from the following detailed description of preferred embodiments when taken in conjunction with the drawings.

### BRIEF DESCRIPTION OF THE DRAWINGS

As noted a more complete understanding of the present invention, and the attendant advantages and features thereof, will be more readily understood by reference to the following detailed description when considered in conjunction with the accompanying drawings wherein:

FIG. 1A is a block diagram of a gamma camera system according to the present invention;

FIG. 1B is a schematic diagram illustrating the various components of the gamma camera system of the present invention;

FIG. 1C is a block diagram showing the components of the gamma camera system of the present invention;

FIG. 1D is schematic view of the gamma camera system of the present invention;

FIG. 2A is a diagrammatic view of gamma ray module of the gamma camera system of FIG. 1

FIG. 2B is a schematic view of a gamma ray detector module of the gamma camera system of FIG. 1;

FIG. 2C is an exploded view of the components of the module;

FIG. 2D is an assembled view of the module;

FIG. 3 is a schematic diagram of the game camera of the gamma camera system of FIG. 1;

FIG. 4 is a schematic diagram of the signal measurement and control system of the gamma camera system of FIG. 1;

FIG. 5 is a schematic diagram of the computer interface board of the gamma camera system of FIG. 1;

FIG. 6 is a flow chart for the process of acquiring an image with the gamma camera of the gamma camera system of FIG. 1;

FIG. 7 is a flow chart for the process of setting up the gamma camera of the gamma camera system of FIG. 1;

FIG. 8 is a flow chart for the process of starting acquisition of an image with the gamma camera of the gamma camera system of FIG. 1;

FIG. 9 is a flow chart for the process of displaying the status of the gamma camera of the gamma camera system of FIG. 1;

FIG. 10 is a flow chart for the process of stopping acquisition of an image with the gamma camera of the gamma camera system of FIG. 1;

FIG. 11 is a flow chart for displaying the image acquired by the gamma camera of the gamma camera system of FIG. 1;

FIG. 12A is a perspective view, partly broken away, showing a configuration for the gamma camera; and

FIG. 12B is a perspective view like FIG. 12A, showing a modified configuration for the gamma camera.

### DETAILED DESCRIPTION OF PREFERRED EMBODIMENTS OF THE INVENTION

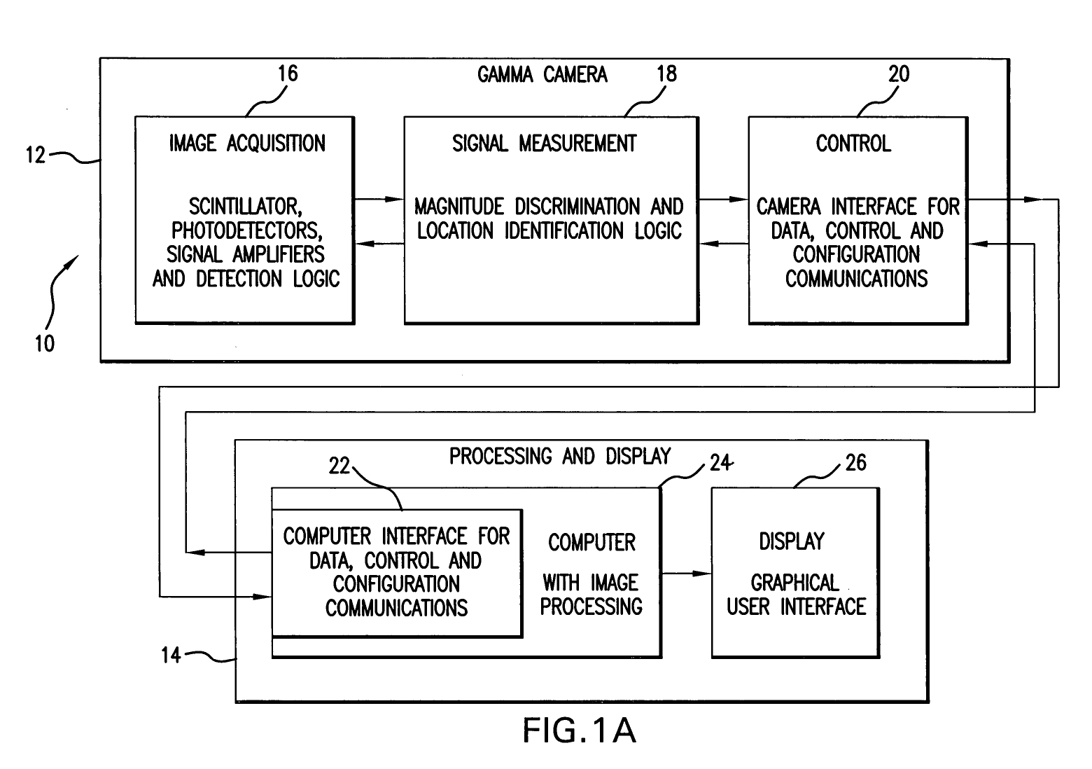

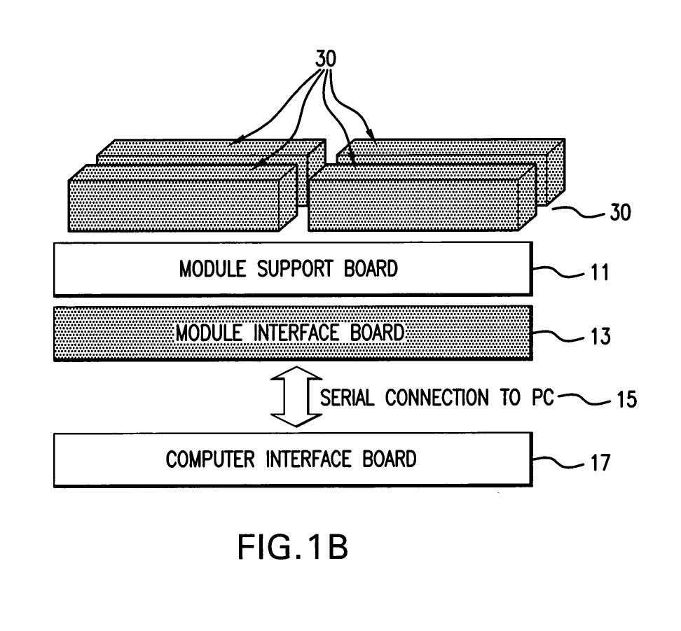

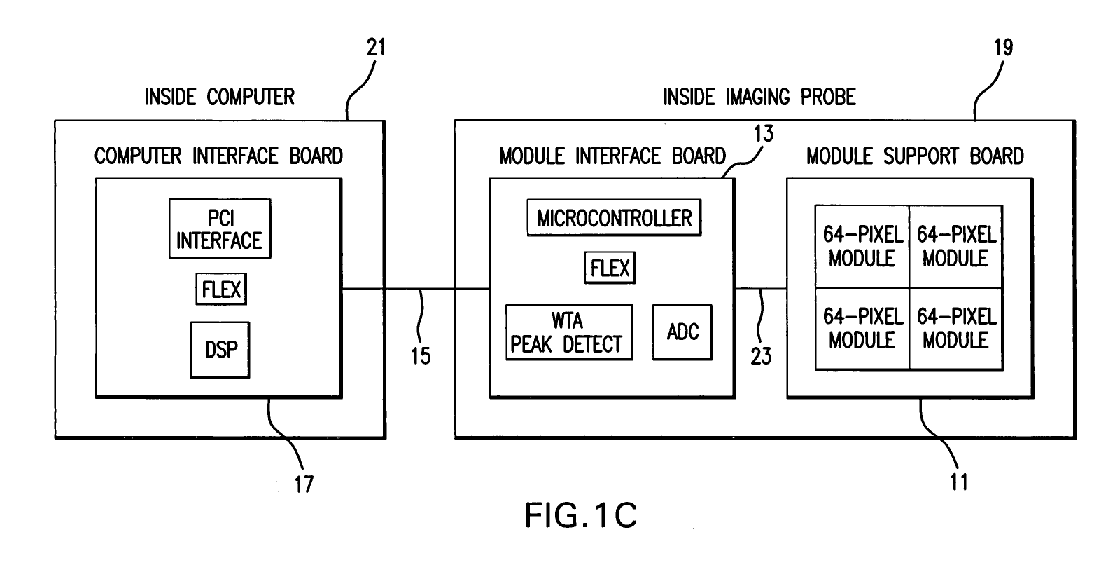

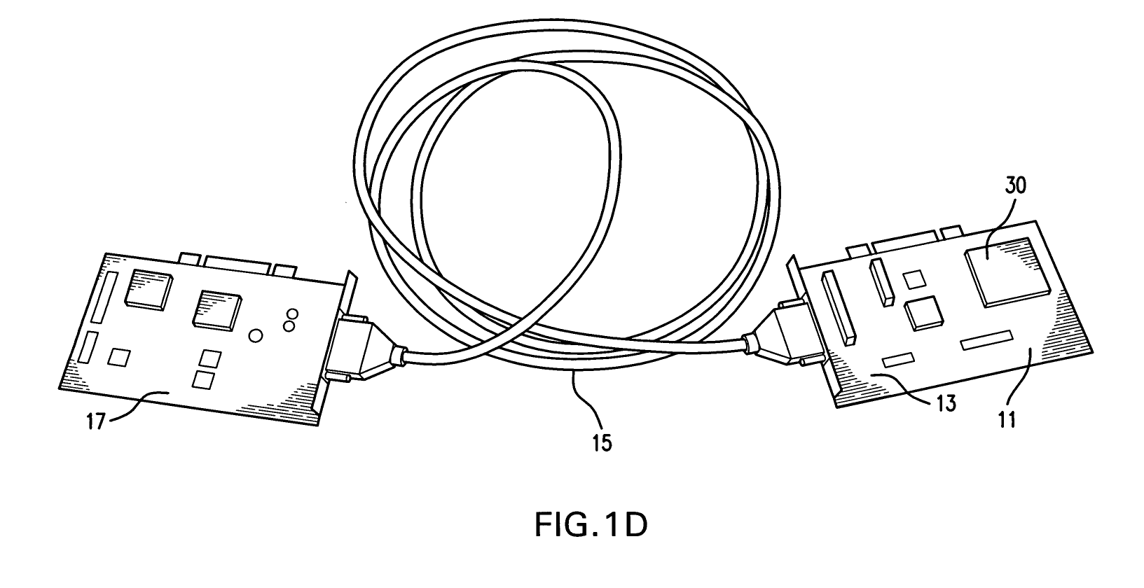

Referring to FIGS. 1A to 1D, the small field of view gamma camera system 10 of the present invention is described, in simple terms, as having the following parts: image acquisition, measurement, control, processing and display. The system comprises a gamma camera 12 in combination with processing and display 14. The gamma camera 12 consists of three main components; an image acquisition module 16 that includes a scintillator with a collimator, photodetectors, signal amplifiers and detection logic; a signal measurement part 18 including magnitude discrimination and location identification logic; and an interface or control 20 including a camera interface for providing data, control and configuration and communications. Processing and display 14 consists of three main components; a computer interface 22 for transmitting and receiving data, control and configuration and communications; a computer 24 having image processing and constituting a control for processing of the image; and a display 26 providing a graphical user interface to provide viewing of the image acquired by the camera 12.

As shown in FIG. 1B the components are organized using modules 30 that are mounted on module support board 11, which is coupled to a module interface board 13, that is connected by a serial interface or connection 15 to a computer PCI interface board 17. As shown in FIG. 1C, the components are distributed according to what is in the imaging probe 19 and what is in the computer 21. The imaging probe 19 contains the module support board 11 and the module interface board 13 which are wired together as illustrated by coupling 23. The output form the imaging probe 19 is fed by serial interface or connection 15 to the computer PCI interface board 17 that is mounted in a conventional PC or similar computer 21, and is connected to the computer's PCI bus. The 4 64-pixel modules 30 are mounted on the module support board 11 in a manner as will be described hereinafter. The module interface board 13 contains a microcontroller, a FLEX, a WTA including a peak detector and an analog to digital converter, as will be explained in more detail hereinafter. The module support board 11 and the module interface board 13 can be independent and coupled by the necessary wiring 23 or they can be both located on the same substrate (PCB) and coupled in this fashion.

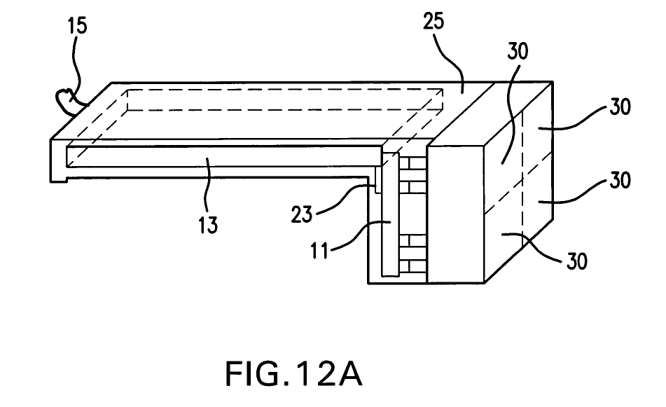

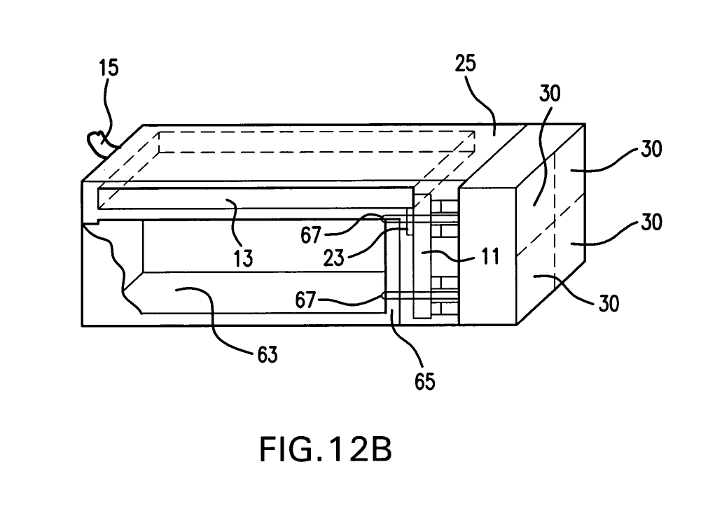

FIG. 12A shows a form of the gamma camera where the camera housing 25 contains the modules 30 at the front in a small profile. The module support board 11 is mounted in the housing 25 as a separate board (PCB) from the module interface board 13 and positioned at right angles to it, to enable the camera to present the smallest possible profile when placed in proximity to the region of interest (ROI) to be monitored. The necessary connections 23 between the two boards are shown schematically. Serial connection 15 is coupled to the module interface board 13 at its end remote from the faces of modules 30. In FIG. 12B, the camera of FIG. 12A is provided with a large heat sink 61 of copper that is a flat plate 63 having its end 65 bent at right angles, to lie beneath or behind the modules 30. Screws or bolts 67 of copper interconnect the end 65 with the heat sinks on the modulators 30.

In FIG. 1D, one can see the arrangement of the modules 30 mounted to a common PCB, the right portion constituting the module support board 11, as indicated, at the left portion constituting the module interface board 13, as indicated. This arrangement has the advantage of using two PCBs with the connections 23, being connectors incorporated into the PCBs during their manufacture. Also evident in FIG. 1D is the serial interface or connection 15 and the computer PCI interface board 17.

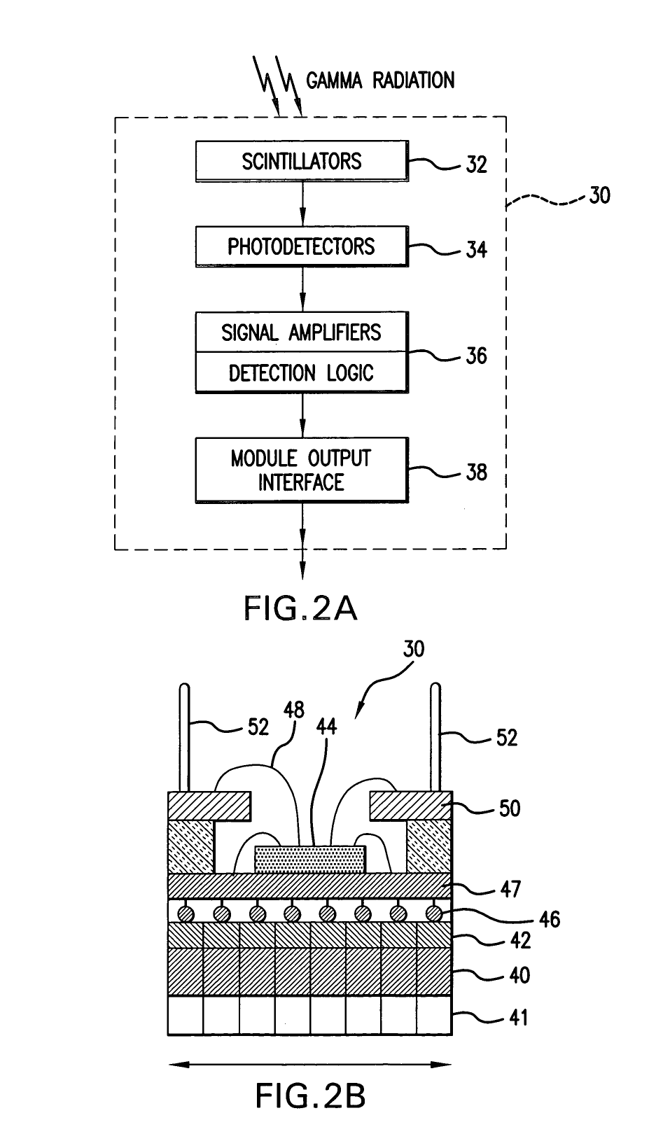

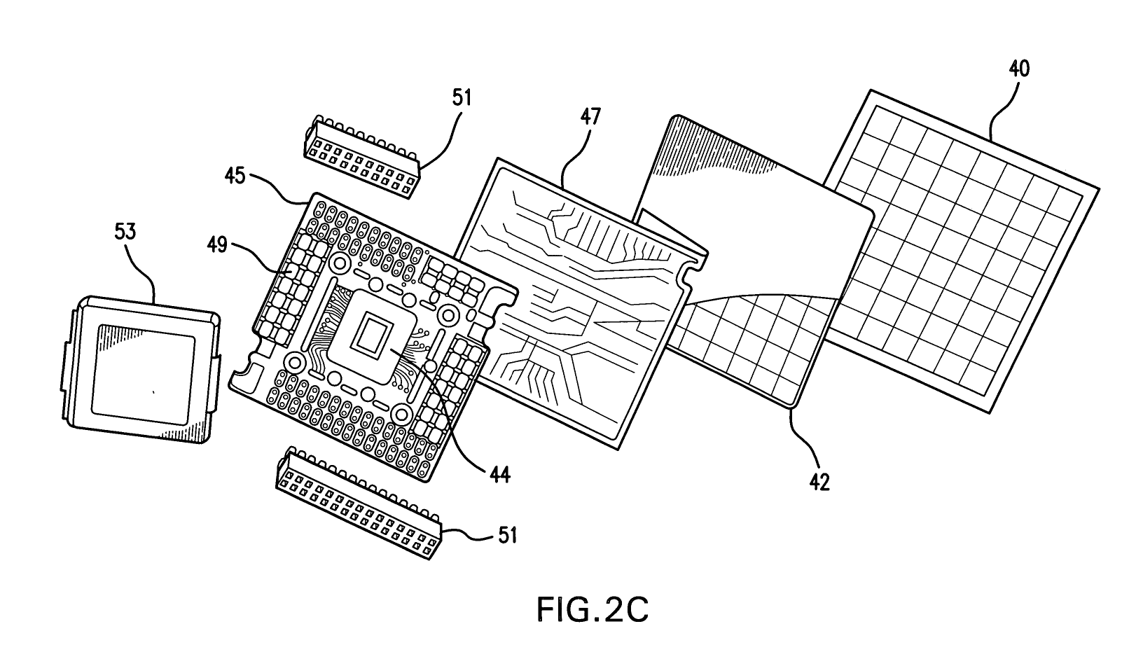

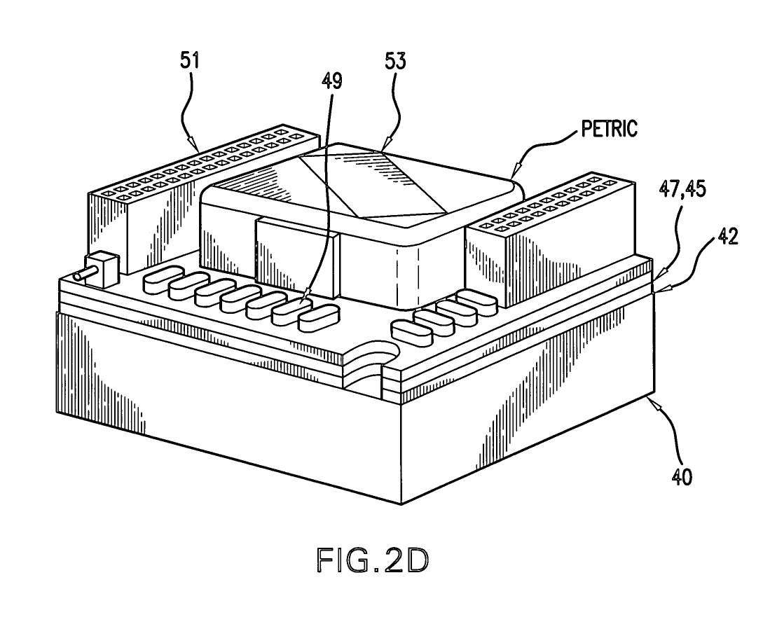

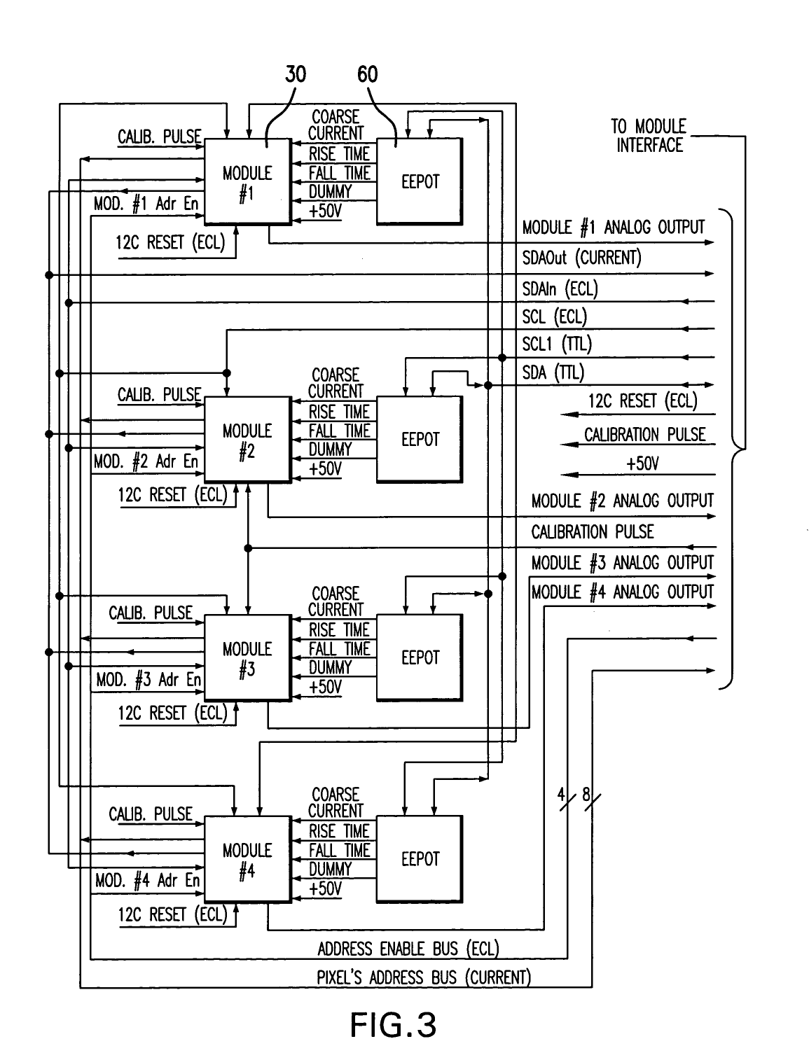

As shown in the block diagram of FIG. 2A, the basic image acquisition is performed in the image acquisition module 16 by four detector modules 30 each having scintillators 32, photodetectors 34 and signal amplifiers and detection logic 36 in the form of a PETRIC 44, and a module output interface 38, The modules 30 are identical in construction, and one module 30 is shown in FIG. 2B. Each module 30 is approximately 20 mm×20 mm in area and consists of a 8×8 array 40 of 2.25×2.25 mm×5 mm deep CsI scintillation crystals (with 0.25 mm optical reflector material between crystals), a low noise 8×8 silicon PIN photodiode array 42 (2.25 mm square pixels with a 0.25 mm gap between them), and a custom integrated circuit (ASIC) 44 readout that provides 64 charge amplifiers and crystal location identification circuitry. A collimator 41 is positioned before the crystal array 40, but is normally a separate element. Circuit 44 is mounted on a PCB 45 that is coupled to a ceramic PCB 47, see FIG. 2C. Contacts 46, formed on the PCB 47 connect the photodiode array 44 with the circuit 44 through the ceramic PCB 47. Leads 48 connect the circuit 44 to input/output circuit 50 that is connected to pins 52 for plugging the module 30 into surface connectors located on a motherboard (module support board 11). Teflon spacers 51 hold the I/O circuits 50 spaced from the integrated circuit 44. The image acquisition also incorporates non-volatile memory (EEPOT) to hold configuration information that controls the performance characteristics of the detector module, as will be explained in more detail with reference to FIG. 3. The EEPOTs are mounted on the module support board separately from the module mounting. This data is written to the memory of the EEPOTs via a serial communications link from the control circuitry.

FIG. 2C shows in an exploded view the various components of the module 30 and module support board 11. As shown, one can see the CsI(TI) array 40, the low noise Si PIN photodiode array 42, the ceramic PCB 47, the printed circuit board 45, surface mounted capacitors 49 forming part of the circuitry, the ASIC 44 (PETRIC), and surface mount connectors 51 for plugging the modules 30 into the PCB. An EMF shield 53 is provided to cover the ASIC 44 (PETRIC).

FIG. 2D shows a preferred embodiment of the module 30. Shown are the 64 crystal array of scintillation crystals 40 (CsI(TI)), an equivalent, one-on-one, array of 64 Si PIN photodiodes 42 characterized with very low leakage current (less than 50 pA/pixel to insure low electronic noise), printed circuit boards comprising one of ceramic 47 providing contacts to the individual Si PIN photodiodes 42 and one normal PCB 45 on which the PETRIC (ASIC 44) is mounted, not shown in this view as it is covered by the copper EMF shield and heat sink 53. Also, shown are the on board capacitors 49 mounted on the edge of the PCB 45, and the onboard connectors 51 mounted on opposite sides of the PCB 45. Connectors 51 mate with complementary on board connectors mounted on the module support board 11.

FIG. 3 shows the complete module support board assembly, showing all major components and important signals. An I²C compatible bus system is used and the conventions and acronyms used are consistent with this system. The Module Support Board Assembly block diagram of FIG. 3 consists of four modules 30 and four electrically programmable potentiometers (EEPOT) 60. In normal operation, each module 30 continuously performs a comparative measurement utilizing a conventional “winner-take-all” (WTA) in order to identify and select the signal of the pixel with the largest amplitude (as compared to all 63 other pixels measured at the output of each pixel's amplifier). It then routes this signal to its Analog Output pin to the Module Interface. Simultaneously, the address of the pixel winner for each module can be read via the Pixel's Address Bus by activating the Address Enable signal corresponding to the particular module.

Modules 30 perform the amplification and detection logic 36 of the PETRIC for determining the signal of highest peak amplitude value and pixel address. The integrated PETRIC circuit performs identification of the scintillation crystal 24 yielding the highest amplitude. Various circuits may be used to perform the sensing function of the PETRIC, and exemplified within this embodiment is the use of a “winner-take-all” (WTA) circuit. For convenience, the term winner-take-all and WTA are often used herein when referring to the sense function of the integrated PETRIC circuit 44. An exemplary WTA can be found in W. W. Moses et al., A “Winner-Take-All” IC for determining the Crystal of Interaction in PET Detectors”, IEEE Transactions on Nuclear Science NS-43, pp. 1615-1618 (1996), which is incorporated herein by reference.

Each module 30 has several internal registers that provide the ability to adjust module functioning as a whole, and also individual characteristics of each pixel, for example, to adjust gain of pixel amplification. These registers can be accessed via an I²C type interface, using signals: SCL (ECL)—clock; SDAIn (SCL)—input data; SDAOut (ECL)—output data; I²C Reset (ECL)—interface reset signal).

Each module 30 has four global settings that affect its functioning; the setting are effected through the associated EEPOT. These are:

1. Coarse Current—this signal sets coarsely the working point for all pixels' amplifiers. Within the module 30 that setting can be adjust more precisely for each pixel individually.

2. Rise Time—specifies the rise time of the output analog signal. This setting affects the whole module 30, and cannot be individually adjusted for each pixel.

3. Fall Time—specifies the fall time of the output analog signal. This setting affects the whole module 30 and cannot be individually adjusted for each pixel.

4. Dummy—specifies the minimum allowed amplitude of the signal at the output of each pixel's amplifier. If signal amplitude is below this level, the pixel signal is ignored inside the module 30.

For example, if the Dummy signal is set at a very high level, at the output of the module 30, one sees only a DC offset. That is because the signal from any pixel will certainly be below the set level. In theory this should reduce system noise, as then low amplitude signals would not affect analog output switch. This setting affects the whole module 30 and cannot be individually adjusted for each pixel.

The adjustment of these four settings is performed with the aid of the integrated circuits that comprise the electrically programmable potentiometer (EEPOT) 60, which are controlled via a serial (I²C) interface (with signals SCL1 and SDA).

A 50 volt bias is necessary for proper module's photodiode operation in order to minimize its leakage current. This voltage is generated on the Computer Interface Board assembly to be described hereinafter.

For initial calibration of the module 30, the design also provides for the ability to connect a Calibration Pulse (Calib. Pulse) signal with known amplitude, individually to the input of each pixel's amplifier. This offers a defined diagnostic capability to the system.

The output of the Module Support Board Assembly, as shown in FIG. 3, consists of the four module 30 analog outputs #1 to #4, the Pixel address bus and the serial data.

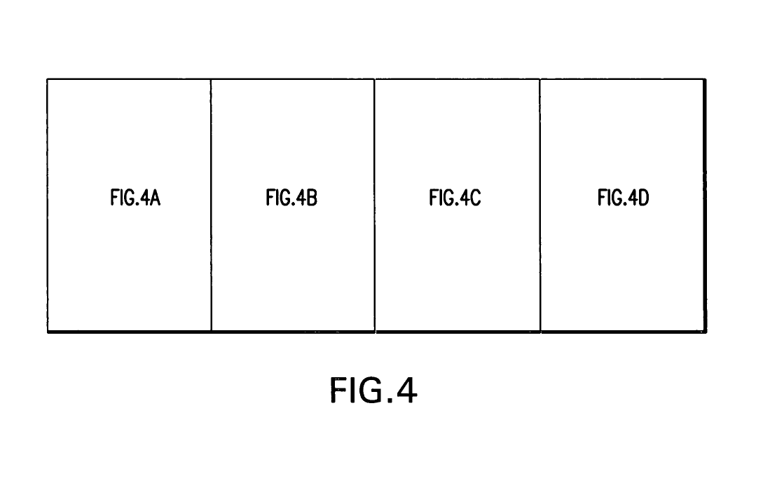

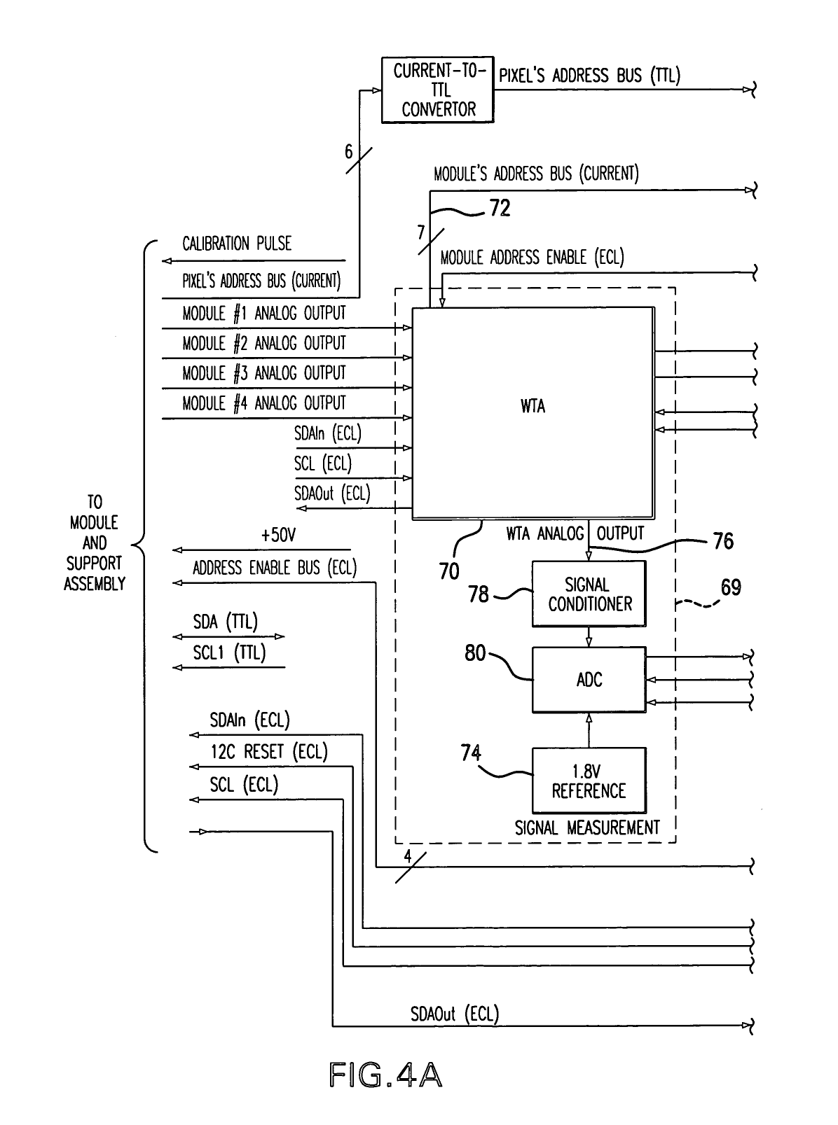

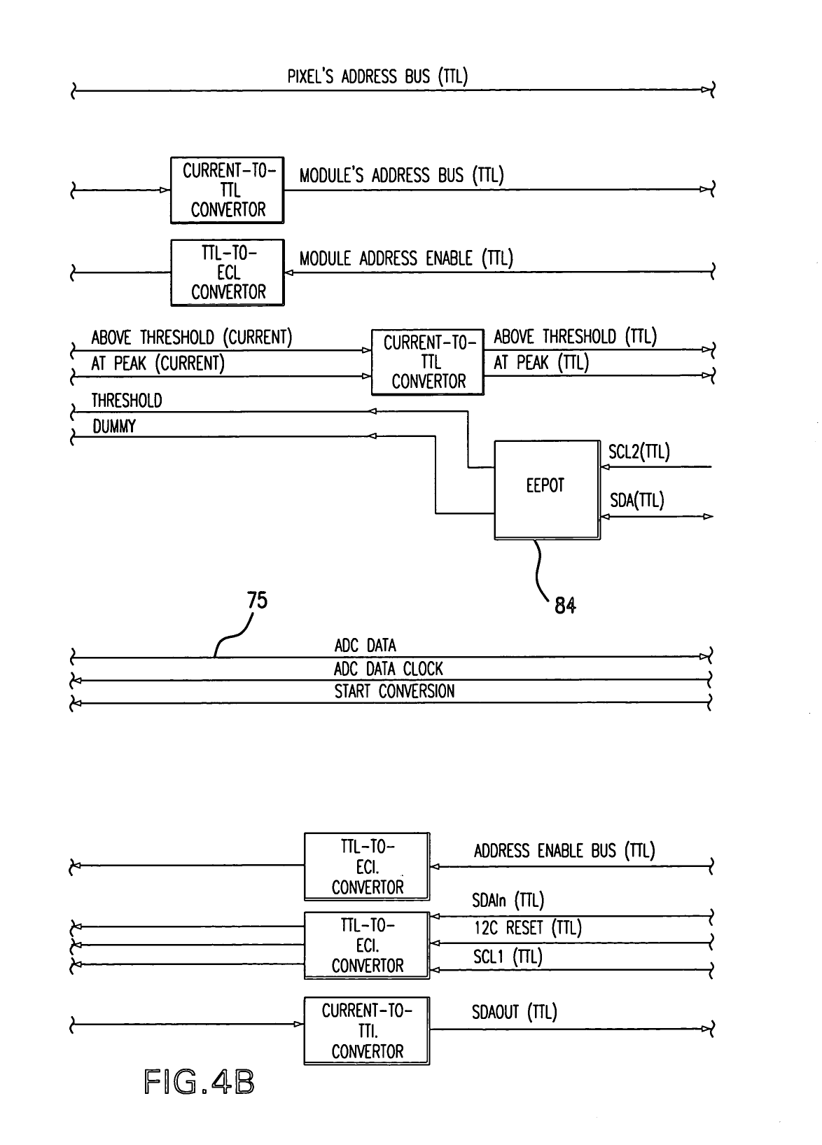

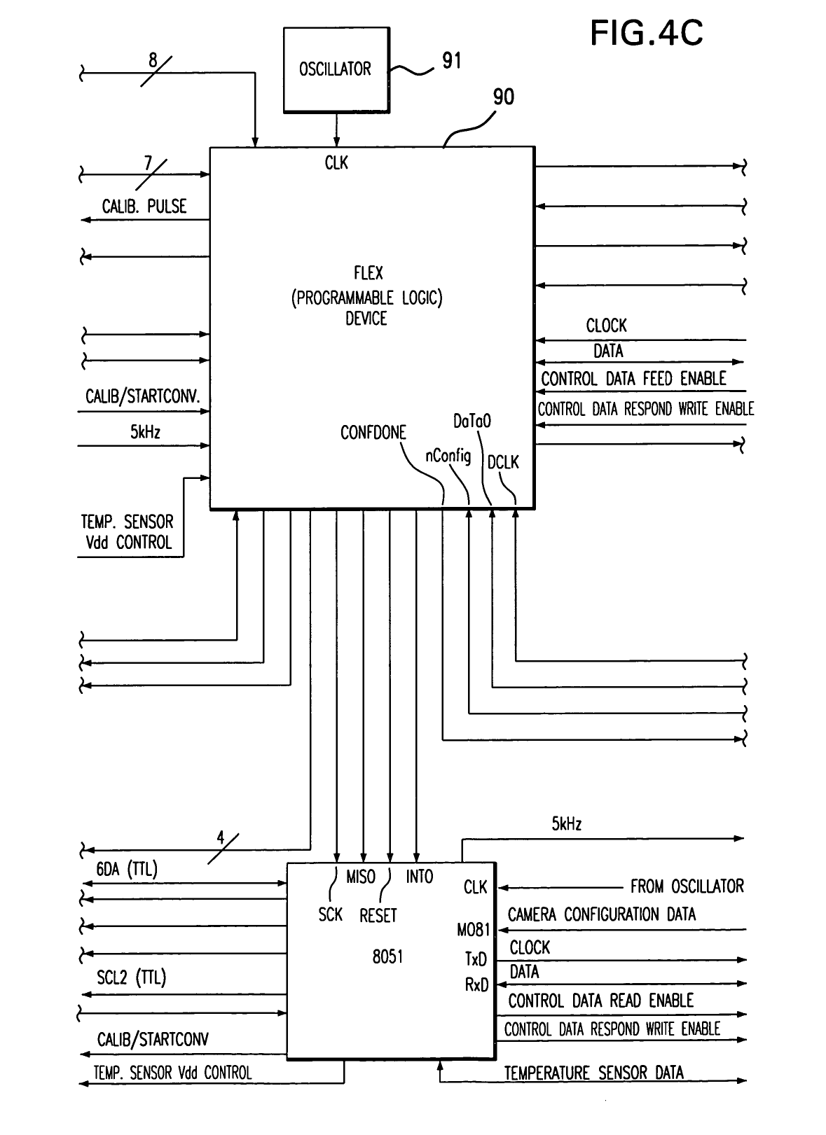

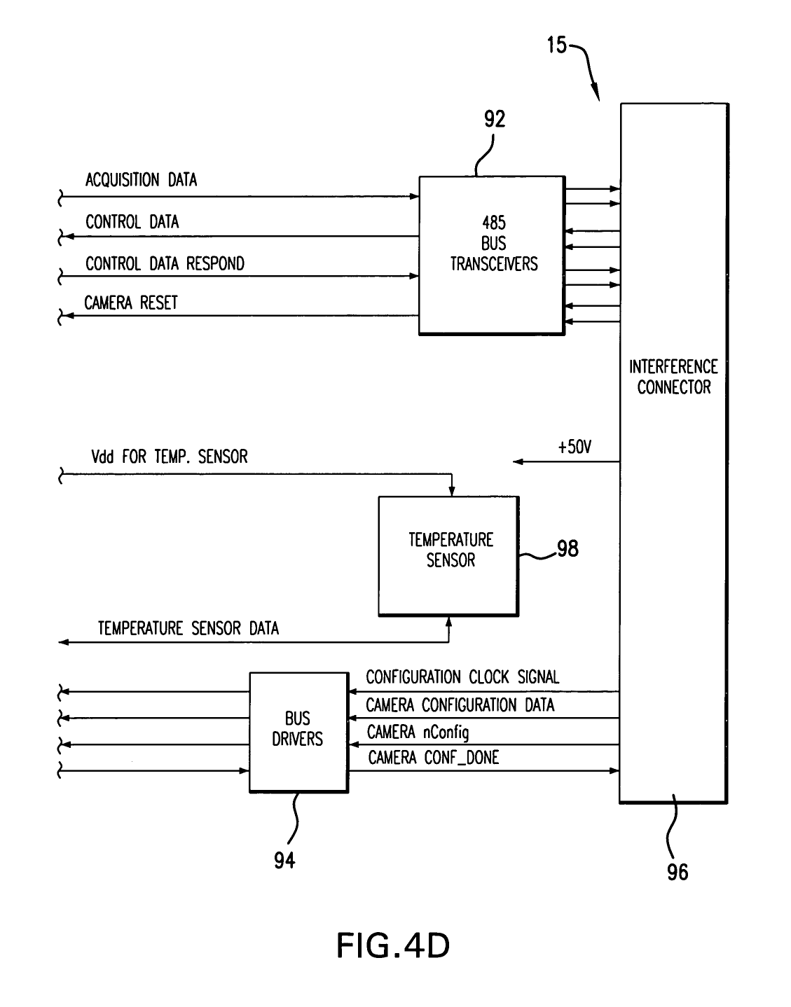

FIG. 4 is a block diagram of the Module Interface Board and performs Signal Measurement and Control of the module support board assembly as shown in FIG. 3, identifying the major circuit functions and signals. This assembly performs collection of the analog signals from the modules 30, selects the module with the highest signal amplitude, digitizes that signal, generates the address of the module winner, reads the address of the pixel winner from the module winner and sends all this information to computer in serial form. MIB also receives control information from PC, decodes it, executes control command and sends back to PC the result of execution.

Signal measurement is effected as follows. The signals exiting from the module consist of analog voltage signals proportional to the energy deposited in the crystal of interaction and the position (digital address) of that crystal. These are routed to signal measurement and position identification processing electronics, incorporating a custom integrated circuit (WTA) 70. It accepts an analog signal from each of the modules 30, continuously identifies the largest one, provides the location address of the corresponding module on digital output lines 72, and passes its amplitude to an analog output line 76 for post processing via a signal conditioner 78 and by an analog to digital converter 80.

The Signal measurement circuit 69 consists of the WTA integrated circuit 70, Signal Conditioner 78, ADC 80 and Reference Voltage. The WTA integrated circuit core 70 operates in a similar manner to the Module 30—it continuously selects the member of the group, i.e. the module, that has the highest amplitude signal on its Analog output. The address of the module winner can be read from the Module's Address Bus by activating the Module Address Enable signal. The WTA device also incorporates an internal Peak Detector circuit and logic that produces the Above Threshold and At Peak signals. These signals are used by the external circuit (FLEX device) to indicate a starting point for analog to digital conversion activation signal (Start Conversion). It also handles the reading and transfer of the conversion result together with the module-winner and the pixel-winner addresses to the computer.

The WTA IC 70 has two external settings: 1) Threshold and 2) Dummy, which can be adjusted with the help of an EEPOT device 84 controlled via its serial (I²C) interface. This Dummy signal is similar to the Module's Dummy signal, in that it specifies the minimum allowed amplitude of the measured signal. The Threshold signal specifies the minimal level of the input analog signal that will cause the Above Threshold output to become active. Thereby, the Threshold input helps to select real signals from the noise.

The WTA device 70 has a number of internal registers used for control of its operation. The access to those registers is gained through a serial communication (I²C type) interface: SCL(ECL)—the clock signal; SDAIn(ECL)—the input data; SDAOut(ECL)—the output data; and I²CReset (ECL)—the interface reset signal.

The WTA device 70 (as well as the Module 30) is powered from −3.3V. Therefore, the analog output signal is shifted to the negative voltage region, 0 to −3 V. However, the ADC 80 (analog to digital converter) can work only with a positive signal, so the Signal Conditioner circuit 78 provides for voltage level shifting, as well as, amplification to produce an ADC full scale input range signal.

After the ADC digitizes the signal, the result can be read via the serial interface: ADC Data Clock—the data strobe, and ADC Data—the magnitude value.

In the design as described, a control portion is provided to ensure smooth signal processing operation (see FIG. 4). The signal measurement circuitry 69 previously described, is directed by control logic contained in a FLEX device 90, FLEX is a registered trademark of the Altera Corporation. This device 90 is an electrically re-programmable integrated circuit. The signal acquisition is performed by and data communicated through the FLEX device 90 and via RS485 bus transceivers 92 and other digital drivers 94, through interface connector 96 via a serial interface to the computer interface board. An imaging processing software application in the DSP on the computer interface board manipulates the data to produce a “view” of what the camera “sees”.

The FLEX device 90 consists mainly of a field programmable gate array and contains all logic that is necessary to communicate with and to control all on board devices. This includes transmission of the acquired data, receiving control commands, and issuing responses. It provides timing for the analog to digital conversion, reading the Module-winner and pixel-winner addresses, and the WTA's peak detector state control. The FLEX device 90 is configured following each system “power on” because of its volatile internal structure. To reconfigure the FLEX device, four signals are used: Configuration clock, Camera configuration data, Camera nConfig and Camera Conf_Done. These signals also provide for the ability to program and reprogram the 8051 microprocessor's internal program flash memory via the SPI (serial peripheral interface port) signals SCK, MISO and MOSI).

The FLEX device 90 sends two types of communications to the computer via the serial connection 15 to the computer interface board 17 in serial format:

1. Acquisition data: a packet that consists of a Start bit, five bits of module address, six bits of pixel address, ten bits of signal magnitude (ADC result) and a Stop bit.

2. Control data: a response as a result of the last received Control command execution. The packet consists of a Start bit, 24 bits of data and a Stop bit.

The FLEX device 90 receives Control command data from the computer. This information packet includes a Start bit, 25 bits of data and a Stop bit. The Camera Reset signal is used to reset the camera (image acquisition) electronics to defined state, and to place the 8051 microcontroller into a reset mode during programming of its Program flash memory.

The various integrated circuits inside the camera generally use a type of I²C serial interface, but some circuits use a 1-wire interface, e.g., the temperature sensor. As a result, the 8051 microcontroller is used to communicate to all of them.

When new Control command data is received by the FLEX device 90, an interrupt to the 8051 (INTO) is generated. The microcontroller 8051 then receives data through its UART port (signals Clock, Data, Control data read enable). After decoding the information and Command execution, it loads Control data response values to the FLEX device internal Respond transmit register via a UART (signals Clock, Data, Control data respond write enable). At the rising edge of the ‘Control data respond write enable’ signal, the FLEX device 90 begins its response data transmission. As a result of the Control command execution, the microcontroller 8051 can perform data transfer to and from:

1. Any Module (using signals SDAIn(TTL), SDAOut(TTL), SCL1(TTL)).

2. WTA (using signals SDAIn(TTL), SDAOut(TTL), SCL1(TTL)).

3. Any EEPOT (using signals SDA(TTL), SCL1 (TTL), SCL2(TTL)).

4. Temperature sensor (using signals Temperature sensor data and Temp. sensor Vdd control).

Clock signals are provided to FLEX 90 and microcontroller 8051 from on board oscillator 91.

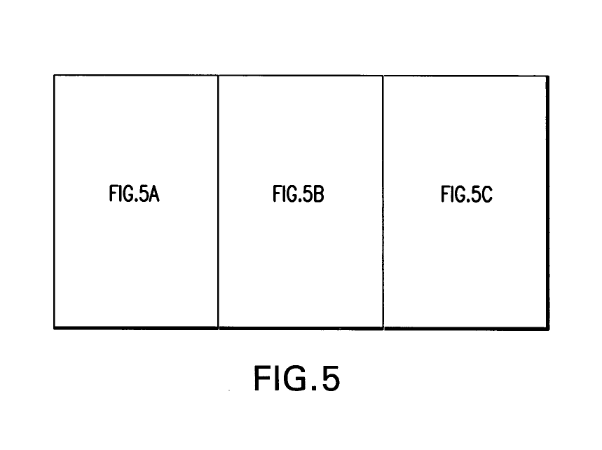

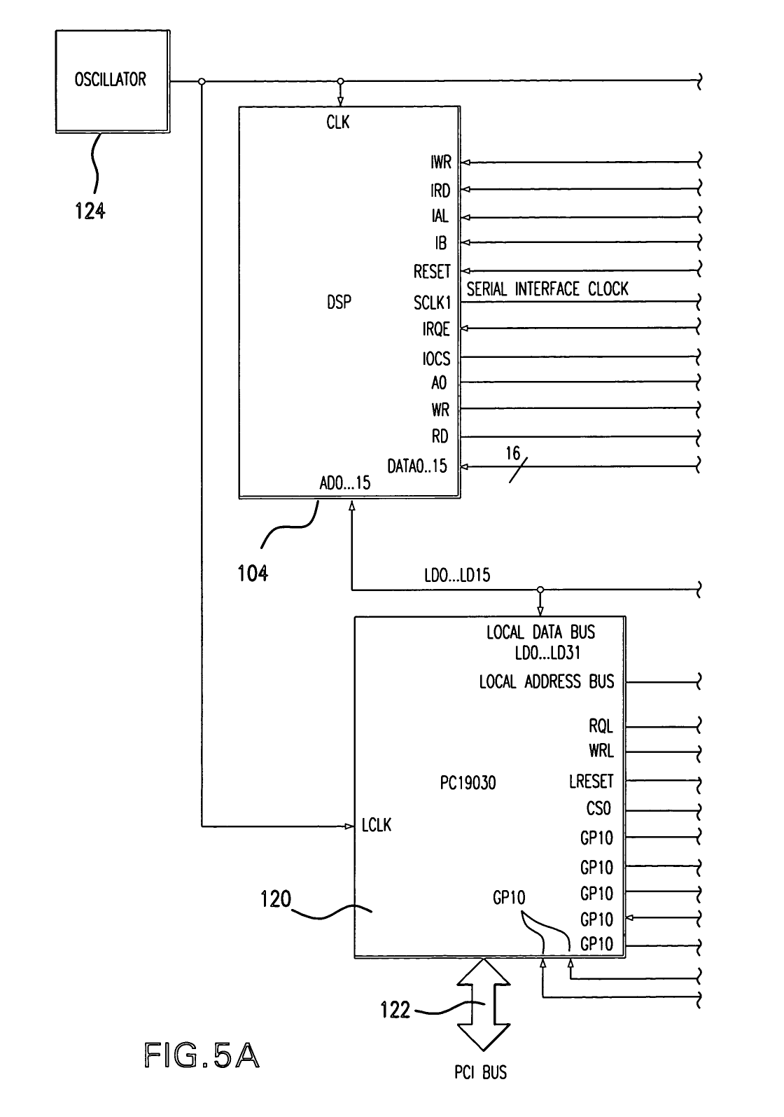

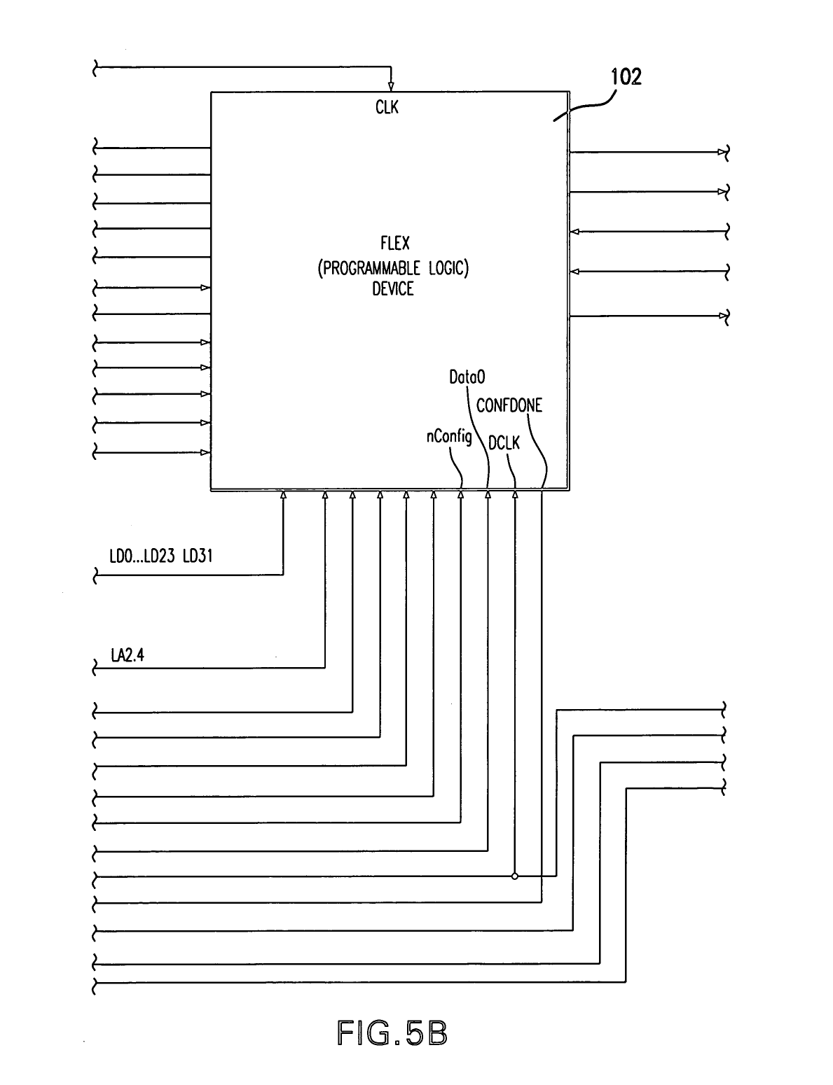

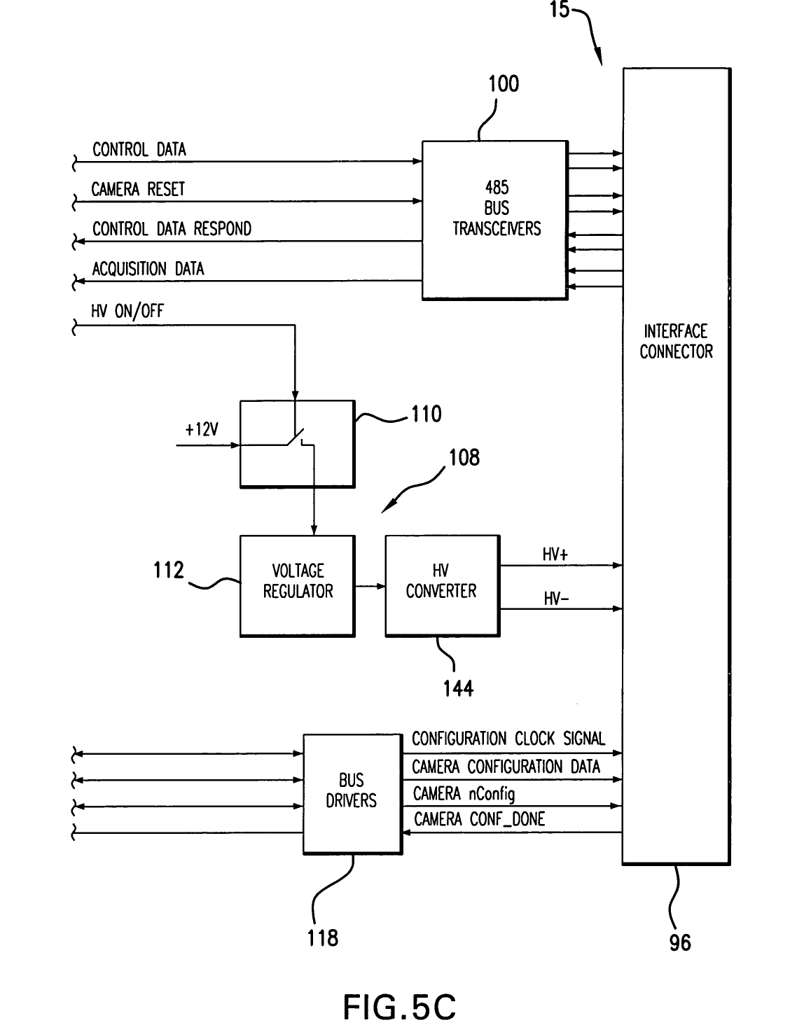

The Computer and Display functions will now be described. The image display application program communicates with the camera assembly via a special computer interface board 17 (FIG. 5). The acquired image data along with control and configuration information flows though this portion of circuitry. This interface is comprised of communications signal transceivers 100, an electrically re-programmable FLEX device 102, a digital signal processor (DSP) 104, a PCI bus bridge IC 120 (PCI9030), and a high voltage power supply 108 (to provide a bias voltage for the detector module).

The Computer Interface comprises the computer interface board (CIB) 17 and is intended to connect the camera assembly to a computer, see FIG. 1A, via the computer's internal PCI bus 122. The CIB 17 consists of three major parts:

1. PCI9030 IC 120 is an integrated circuit that provides communication between the PCI bus and CIB devices and camera.

2. FLEX device 102 containing all glue logic to synchronize the work of all onboard devices, internal registers to control system work, serial-to-parallel and parallel-to-serial data converters.

3. DSP 104 performs data processing and storage of the acquired image in its data memory.

All onboard devices use the same clock generator. This simplifies the process of synchronization between all ICs and reduces design complexity, see oscillator 124.

The PCI 9030 IC 120 is a bridge that provides data transfer between the PCI bus 122 and the on board local bus that is used as the bus for interconnection of all onboard devices. From the computer's point of view, the CIB 17 is an I/O device, with a 32 bit width data bus. The board does not use an interrupt line or DMA data transfer.

To select specified onboard registers LA2. LA4, local address lines are used together with signals CS0. RDL and WRL strobe lines read and write data correspondingly. Data to/from any onboard device are transferred through LD0 . . . LD31, the local data bus. FLEX device 102 that must be programmed following every system “power on”. To perform this procedure, the PCI9030 GPIOs are used. The PCI9030 ReadyL input allows an external device to prolong a data transfer cycle.

The FLEX device 102 contains:

1. circuits that control timing during data transfer between the Local bus and the PCI bus;

2. the register that controls the state of onboard devices and camera: DSP and camera assembly reset signals, HV On/Off signal etc.;

3. the circuit that receives acquisition data from the camera, converts them to parallel format and generates an interrupt signal for DSP, informing it that new data has arrived;

4. the circuit that receives the Control data for camera devices in parallel format and sends them to the camera through serial interface 15 (Control data output);

5. the circuit that receives Control data response from the camera in serial format and converts them to parallel form for further transfer to PC memory via the PCI bus 122; and

6. the circuit that allows the computer to gain access to the DSP Program and Data memory to load program code and retrieve the image during acquisition in real time mode.

The DSP 104 performs the preliminary processing of the acquired data, stores the image in its Data memory, analyses acquisition Stop condition, and generates the clock signal for the serial interface (Serial Interface Clock signal), etc. of FLEX 102.

Because of its high speed, DSP 104 can guarantee no missing codes and allows use of the camera even with relatively slow computers. The DSP's Program/Data memory can be read or written to through ADO . . . D15 address lines. This is the so-called IDMA mode. Signals IS, IAL, IRD, IWR are used for this type of data transfer control.

To read new acquired data from the internal registers of FLEX 102, DSP's data lines Data 0 . . . Data 15 are used. Signals IOCS and AO select the necessary register and the RD signal strobes the data. The DSP's IRQE line is used as interrupt input to inform it that new data has been received.

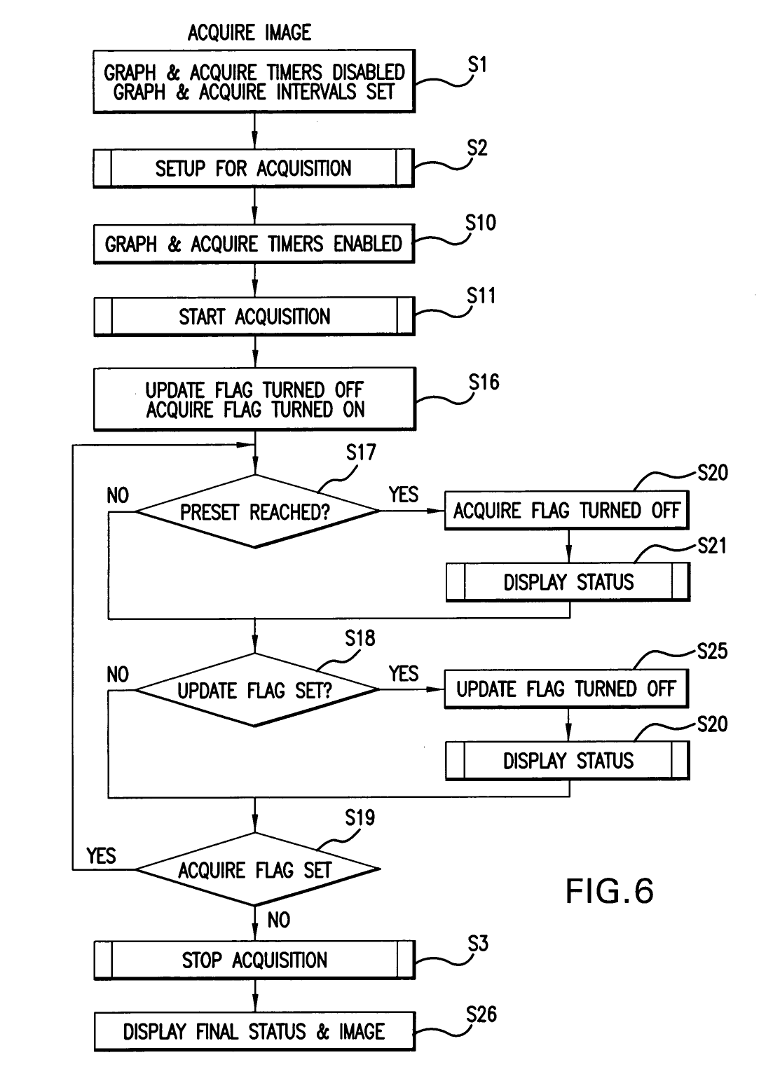

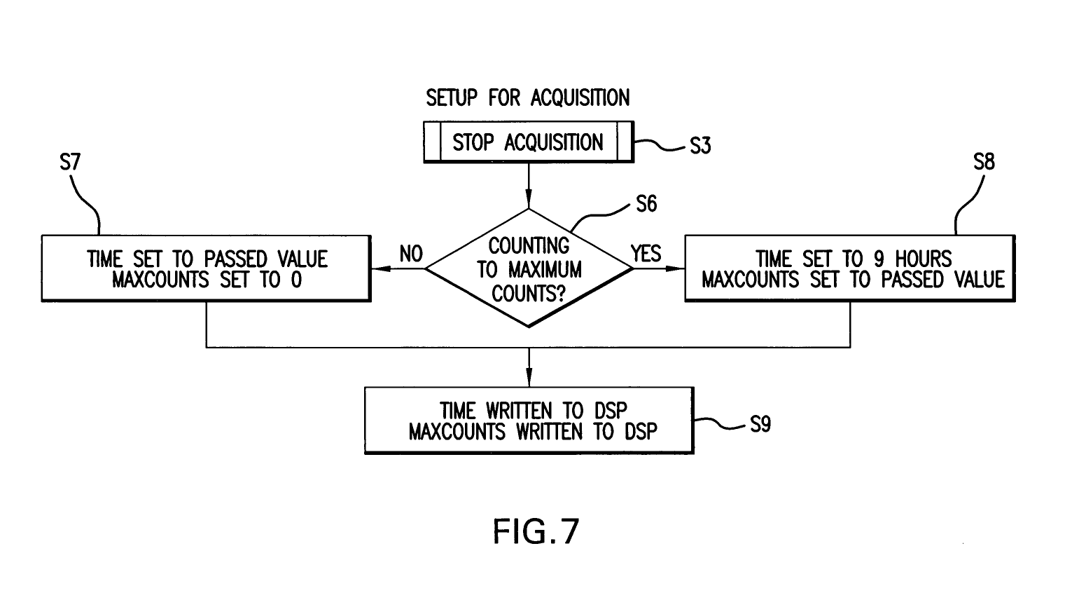

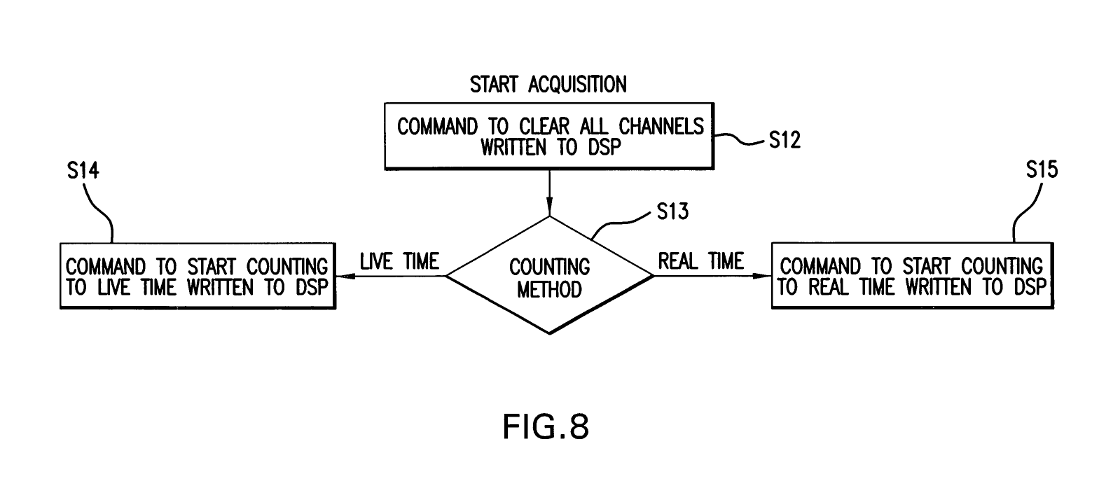

Reference is now made to FIG. 6, which shows a flow chart of the main program routine for the small field of view gamma camera system described above. In step S1 Graph and Acquire Timers are disabled and the Graph and Timer Intervals are set. Next the program moves to step S2 that initiates the Setup for Acquisition subroutine, which is shown in FIG. 7. The initial step S3 in the Setup for Acquisition subroutine is the Stop Acquisition subroutine shown in detail in FIG. 10. The subroutine for Stop Acquisition commands in step S4 that acquisition stop being written to DSP 104. Next in step S5, the Acquisition and Graph Timers are disabled. The program now loops back to the Setup for Acquisition subroutine shown in FIG. 7, and in step S6 a decision is made concerning counting to maximum counts. If NO, then the program moves to step S7 where time is set to passed value and MaxCounts is set to zero (0). If the response to the decision in step S6 is YES, the program moves to step S8 where Time is Set to 9 hours, and MacCounts is set to passed value. Both steps S7 and S8 continue the program to step S9 where Time is written to DSP 104 and MaxCounts are written to DSP 104. The program returns to the main routine, see FIG. 6, and in step S10 the Graph and Acquire Timers are both enabled. Now the program advances to step S11 where the Start Acquisition subroutine is run, see FIG. 8 for details. In step S12 a Command is issued to Clear all channels written to the DSP 104. Next a decision is made in step S13 about the Counting Method, i.e. Live Time or Real

Time. If Live Time is decided, then the subroutine moves to step S14 where the Command is given to Start Counting to Live Time written to DSP 104. If Real Time is decided, the subroutine moves to step S15 where the Command is issued to Start Counting to Real Time written to DSP 104. The subroutine completed, the program returns to the main program routine to step S16 where Update Flag is turned OFF, and Acquire Flag is turned ON. The main routine continues to step S17 where a decision is made whether Preset has been reached. If NO, the program moves to step S18 where a decision is made concerning whether Update Flag is set. If NO, the routine continues to step S19 where a decision is taken regarding whether Acquire Flag is set. If YES, the program loops back to step S17.

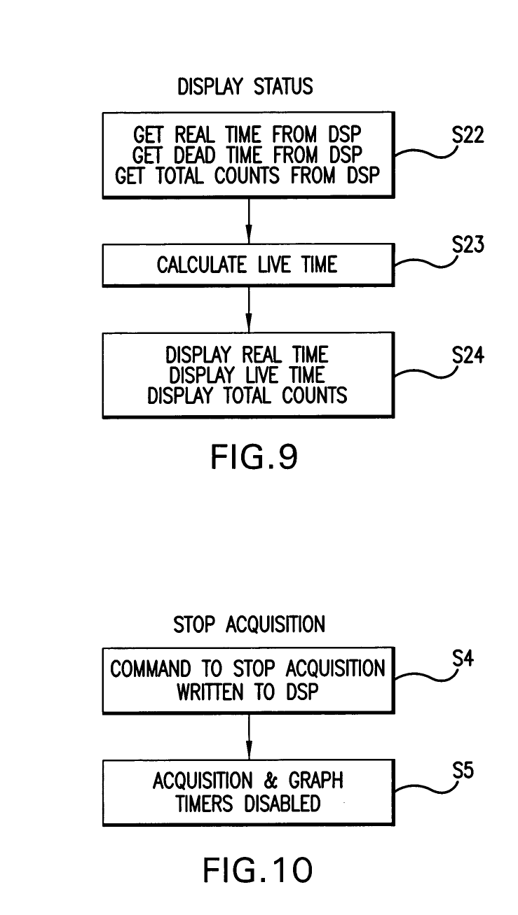

If the decision taken at step S17 is YES, that Preset has been reached, the routine advances to step S20 where the Acquire Flag is turned OFF, an the routine continues to the Display Status subroutine in step S21, and the subroutine shown in detail in FIG. 9 is run. In step S22 of the Display Status subroutine, the commands are given to get Real Time from DSP 104, get Dead Time from DSP 104 and to get Total Counts from DSP 104, essentially a fetch. Next, in step S23 the subroutine calculates Live Time and advances to step S24 where Real Time, Live Time and Total Counts are displayed. Next the subroutine returns to the main program or routine by going to step S18.

In similar fashion, if the decision taken at step S18 is YES, then Update flag is turned OFF in step S25, and then, the program moves to subroutine Display Status step S20 and the subroutine is run, as described above and in FIG. 9, after which the subroutine returns to the main routine to step S19.

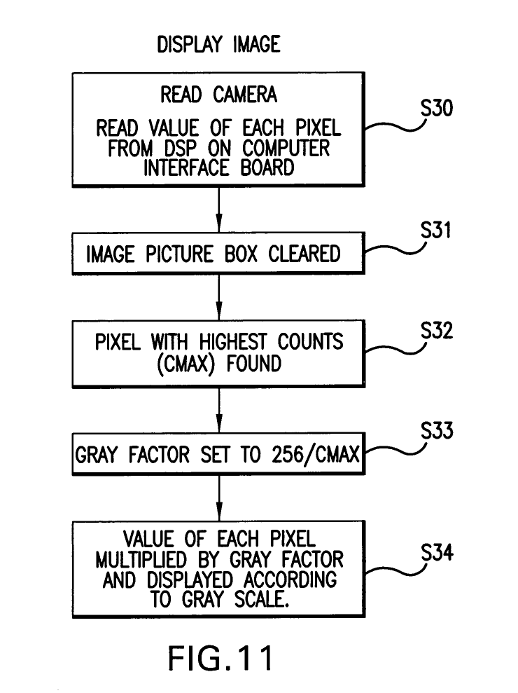

If the decision in step S19 is NO, the Acquire Flag is not set, and the program moves to step S3, the Stop Acquisition subroutine shown in and described with reference to FIG. 10. Finally, the main routine advances to step S26 where the Final Status and Image are displayed. In addition to the routines described, a further routine Is shown in FIG. 11 regarding Display Image. This routine is used by the main routine whenever a “Graph Timer” event occurs. A “Graph Timer” event triggers an interrupt that is used to assure a periodic update of acquired data and displayed image. The routine shown in FIG. 11 comprises the following steps. In step S30, the camera is read by reading the value of each pixel from DSP 104 on the computer interface board. Next, the program advances to step S31 where the image box is cleared. Then in step S32, the pixel with highest counts (CMax) found. In step S33 the Gray Factor is set to 256/CMax. Finally, in step S34, the value of each pixel is multiplied by Gray Factor and displayed according to Gray Scale.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A gamma camera system having a small field of view comprising a plurality of modules, a support on which the modules are mounted, a module interface including signal amplifier and first detection logic, a computer interface for mounting in a computer and connecting to an internal bus in the computer, a serial data connection between the module interface and the computer interface, each said module including a scintillation crystal array, a photodiode array coupled to the scintillation crystal array, second detection logic coupled to the array of photodiodes for reception of data in parallel and to determine the crystal of highest peak analog signal and its address in the array and providing an output thereof, the first detection logic of the module interface receiving the analog outputs of the second detection logics and determining the crystal of the highest peak analog signal of all the modules and its address in the arrays and providing an analog output thereof, an analog-to-digital converter receiving the output of the first detection logic and outputting a corresponding digital signal, a first controller mounted on the module interface to receive said digital signals and to output in serial data fashion, a serial connection between the module interface and the computer interface receiving the serialized digital data signals output by the first controller, a second controller mounted on the computer interface receiving the serialized digital data signals from the serial connection, microprocessor with memory mounted on the computer interface to receive the digital data signals from the second controller, store the signals and output the signals in parallel data fashion to the computer via its internal bus.

2. A gamma camera system having a small field of view according to claim 1 wherein the second detection logic includes a PETRIC circuit.

3. A gamma camera system having a small field of view according to claim 2 wherein the PETRIC circuit includes a “winner-take-all” circuit.

4. A gamma camera system having a small field of view according to claim 1 wherein the second detection logic includes a programmable non-volatile memory.

5. A gamma camera system having a small field of view according to claim 1 wherein the first detection logic includes a PETRIC circuit.

6. A gamma camera system having a small field of view according to claim 5 wherein the PETRIC circuit includes a “winner-take-all” circuit.

7. A gamma camera system having a small field of view according to claim 1 wherein the first controller includes programmable logic devices.

8. A gamma camera system having a small field of view according to claim 1 wherein the first controller includes a microprocessor.

9. A gamma camera system having a small field of view according to claim 1 wherein second controller includes programmable logic devices.

10. A gamma camera system having a small field of view according to claim 1 wherein a high voltage power supply is provided on the computer interface.

11. A gamma camera system having a small field of view according to claim 1 wherein the computer interface includes PCI circuitry to couple to a computer internal PCI bus.

12. A gamma camera for use in a gamma camera system with a small field of view comprising a plurality of modules, a support on which the modules are mounted, a module interface including signal amplifier and first detection logic, each said module including a scintillation crystal array, a photodiode array coupled to the scintillation crystal array, second detection logic coupled to the array of photodiodes for reception of data in parallel and to determine the crystal of highest peak analog signal and its address in the array and providing an output thereof, the first detection logic of the module interface receiving the analog outputs of the second detection logics and determining the crystal of the highest peak analog signal of all the modules and its address in the arrays and providing an analog output thereof, an analog-to-digital converter receiving the output of the first detection logic and outputting a corresponding digital signal, a controller mounted on the module interface to receive said digital signals and to output in serial data fashion to a serial connection between the module interface and a computer for introduction into the computer via its internal bus.

13. A gamma camera having a small field of view according to claim 12 wherein the second detection logic includes a PETRIC circuit.

14. A gamma camera having a small field of view according to claim 13 wherein the PETRIC circuit includes a “winner-take-all” circuit.

15. A gamma camera having a small field of view according to claim 12 wherein the second detection logic includes a programmable non-volatile memory.

16. A gamma camera having a small field of view according to claim 12 wherein the first detection logic includes a PETRIC circuit.

17. A gamma camera having a small field of view according to claim 16 wherein the PETRIC circuit includes a “winner-take-all” circuit.

18. A gamma camera having a small field of view according to claim 12 wherein the first controller includes programmable logic devices.

19. A gamma camera having a small field of view according to claim 12 wherein the first controller includes a microcontroller.

20. A gamma camera having a small field of view according to claim 12 wherein the second controller includes programmable logic devices.

21. A gamma camera according to claim 12 wherein four modules are arranged in a 2×2 array, and wherein each module provides an 8×8 array.

22. A gamma camera according to claim 21 wherein each module is about 20 mm wide and 20 mm long and includes CsI(TI) crystals about 2.25 mm×2.25 mm×5 mm deep.

23. A gamma camera according to claim 22 wherein module includes 8×8 Si PIN photodiodes.

24. A gamma camera system having a small field of view comprising a plurality of modules, a module support board on which the modules are mounted, a module interface board, signal amplifier and detection logic mounted on the module support board, a computer interface board mounted in a computer and connected to an internal bus in the computer, a serial connection between the module support board and the computer interface board, each said module including a scintillation crystal array, a photodiode array coupled to the scintillation crystal array, a first PETRIC circuit coupled to the array of photodiodes in parallel to determine the crystal of highest peak analog signal and its address in the array and providing an output thereof, a second PETRIC circuit receiving the analog outputs of the first PETRIC circuits and determining the crystal of the highest peak analog signal of all the modules and its address in the arrays and providing an output thereof, an analog-to-digital converter receiving the output of the second PETRIC and outputting a corresponding digital signal, a first programmable field gate array mounted on the module interface board to receive said digital signal and to output in serial fashion, a serial connection between the module interface board and the computer interface board receiving the serialized digital signals output by the first programmable field gate array, a second programmable field gate array mounted on the computer interface board receiving the serialized digital signals from the serial connection, microprocessor with memory mounted on the computer interface board to receive the digital signals from the second programmable field gate array, store the signals and output the signals in parallel fashion, and a circuit mounted on the computer interface board to receive the signals in parallel from the microprocessor and to forward them to the computer via its internal bus.

25. A gamma camera system according to claim 24 where in an EEPOT is mounted on the module support board controlling the module.

26. A method of imaging comprising the steps of
h. detecting on a pixel by pixel basis gamma radiation by a small field of view camera having a module array,
i. amplifying and determining the pixel of each module with the highest amplitude signal,
j. sending the determined amplitude signals of all the modules in parallel to a circuit to select, as between these determined amplitude signals, which pixel has the highest amplitude,
k. reading the pixel address of the selected pixel in digital form,
l. converting the highest amplitude of the selected pixel into digital form,
m. sending the digital signals via a serial interface to a computer interface board and storing the signals in a memory, and
n. sending the stored signals in parallel to an input bus of the computer for display by the computer.

27. The method of claim 26 wherein steps a. and b. are performed by a PETRIC.

28. The method of claim 26 wherein the input bus is a PCI bus.
